(19) United States
(12) Patent Application Publication
(10) Pub. No.: US 2015/0258841 A1
(43) Pub. Date: Sep. 17, 2015

(54) Writing Implement Holder

(71) Applicant: Robert A. Briganti, Los Altos, CA (US)

(72) Inventor: Robert A. Briganti, Los Altos, CA (US)

(21) Appl. No.: 14/726,506

(22) Filed: May 30, 2015

Related U.S. Application Data
(63) Continuation-in-part of application No. 13/720,997, filed on Dec. 19, 2012.

(51) Int. Cl. B42F 9/00; F16B 2/10; F16B 2/22

(52) U.S. Cl. CPC B42F 9/002; F16B 2/22; F16B 2/10

(57) ABSTRACT

A device for removably attaching a writing implement to a clipboard clip comprises at least one flexible tab formed parallel to an outer surface of the clip and formed therefrom to hold the writing implement between the outer surface of the clip and an arcuate portion of the flexible tab(s). The flexible tab(s) and the outer surface of the clip form a cavity fashioned to retain the writing implement removable in a motion substantially parallel to the upper surface of the clip. A foundation plane, an upper plane and a spring hinge there between and at least one gripping appendage attach to the clip board or the clip. An elongated “u” shaped to cavity is fashioned therefrom to retain the writing implement, whereby the spring hinge deflects and the writing implement is removed responsive to a manual force on the writing implement in a motion substantially parallel to the foundation plane.

### CROSS-REFERENCE TO RELATED APPLICATION

This application claims the benefit of the priority date of earlier filed U.S. Provisional Patent Applications Ser. No. 61/627,228, titled ‘Writing Implement Holder for Clip Board’ filed by Robert Briganti, and U.S. Provisional Patent Application Ser. No. 61/630,892 titled, “Writing Implement Holder With Advertisement Space for Clip Board,” and is a continuation-in-part (CIP) of U.S. Non-Provisional patent application Ser. No. 13/720,997 titled, “Writing to Implement Holder,” each incorporated herein by reference in its entirety.

### BACKGROUND AND FIELD OF INVENTION

Clip boards are used to hold paper or forms so they can be filled out or written on away from a desk providing a flat hard surface with a clip to hold the paper or form. A writing implement sometimes accompanies the clip board and is sometimes tethered to the board. However, a tether creates safety issues for the sharp writing implements swinging to and fro during transfer of the clipboard. Perhaps for this reason and more, there are generally no commercially available clipboards with writing implement holders or separately available and inexpensive writing implement holders fashioned to easily attach to a clipboard.

There has therefore been a long felt for a low cost integrated clipboard and writing implement holder or a separate commercially available writing implement holder which avoids the safety issues of a tethered writing implement of a conventional clipboard.

### SUMMARY OF THE INVENTION

A device is disclosed for removably attaching a writing implement to a clipboard clip, comprising at least one flexible tab formed parallel to an outer surface of the clip and formed therefrom. The flexible tab(s) are adapted to hold the writing implement between the outer surface of the clip and an arcuate portion of the flexible tab(s), the flexible tab(s) and the outer surface of the clip forming in combination a cavity fashioned to retain the writing implement removable in a motion substantially parallel to the upper surface of the clip.

A device is also disclosed for removably attaching a writing implement to a clipboard. The device comprises a jaw having a foundation plane, an upper plane and a spring hinge there between and at least one gripping tab formed parallel to the upper plane opposite the spring hinge and formed therefrom. The gripping tab(s) are adapted to hold the writing implement between the foundation plane of the jaw and an arcuate portion of the gripping tab(s). The gripping tab(s) and the foundation plane of the jaw form in combination a cavity fashioned to retain the writing implement removable in a motion substantially parallel to the foundation plane.

A holder for removably attaching a writing implement to a clipboard is additionally disclosed. The holder comprises a foundation plane, an upper plane and a spring hinge there between and at least one gripping appendage formed parallel to the upper plane opposite the spring hinge and formed therefrom. The implement holder is formed in an elongated “u” shaped cavity fashioned to retain the writing implement therein. The spring hinge deflects and the writing implement is removed therefrom responsive to a manual force on the writing implement in a motion substantially parallel to the foundation plane.

Other aspects and advantages of embodiments of the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a clipboard clip in a portrait orientation with at least one flexible tab for removably attaching a writing implement thereto in accordance with a disclosed embodiment.

FIG. 2 depicts an enlarged view of the clipboard clip area in a portrait orientation in accordance with a disclosed embodiment.

FIG. 3a depicts a side view of the clip area and how the implement enters the holder in accordance with a disclosed embodiment.

FIG. 3b depicts a side view of the clip area and how the implement is held in the holder in accordance with a disclosed embodiment.

FIG. 4 depicts an isometric view of a separate writing implement holder in accordance with a disclosed embodiment.

FIG. 5 depicts the separate writing implement holder on the clip board clip in accordance with a disclosed embodiment.

FIG. 6 depicts a side elevational view of the separate writing implement holder positioned on a clipboard clip in accordance with a disclosed embodiment.

Throughout the description, similar and same reference numbers may be used to identify similar and same elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

The term ‘writing implement’ as used throughout the present disclosure refers to a conventional pen, pencil, marker and electronic versions thereof including electronic stylus and pointers. The term ‘clipboard’ or ‘clip board’ therefore also refers to a conventional clipboard including a rigid slab or board outfitted with a clip and also to electronic versions including tablets, laptops and other personal digital assistant devices and even cell phones. The term ‘jaw’ refers to a retaining device which attaches to a clipboard clip for retaining a writing implement as disclosed herein. The term ‘tab’ refers to a small flap or strip of material attached to or projecting from the clip or jaw device, used to hold or manipulate a writing instrument. The ‘holder’ therefore may include the clip and tabs or it may also include the clip and a jaw device for attachment thereto for holding a writing implement.

The disclosure removably attaches a writing implement to a clipboard clip or to the clipboard board itself. The disclosure comprises one or more holding means in the form of a tab or a set of tabs or some other mechanical containment means fashioned to hold the writing implement within detents or to between ridges or in a groove etc. using spring force or other mechanical force for constrainment substantially fixing the writing implement in relation to the clipboard. The means may be tabs or arms or fingers or loops etc. The tabs or arms etc may pivot as well and use separate spring elements. The constrainment means can be deformed elastically by manual force moving the implement into an open end of a gap between the constrainment means and a jaw inner surface. The writing implement may also be held between two sets of constrainment means. These constrainment means are appendages of the clipboard clip or of a jaw attached thereto. The implement is then retained in place on the clip of the clipboard until it is needed. It can be released by applying force to the implement causing elastic deformation of the constrainment means so that the implement can escape therefrom. The constrainment means may also utilize a clasp or locking means. The device may also comprise an attachable element achieving all or part of the disclosed functions.

Embodiments of the disclosure depicted in the drawings and detailed below may be fabricated by cutting sheet metal or other flat stock material and formed into the disclosed shapes. Tabs may also be punched therefrom or attached separately with spot welds, rivets, screws, glue or tape, etc. The elements can be formed together or separately and can also be molded by any of the many molding techniques known to those of ordinary skill in the art. The constrainment means may be formed by modifying the mold or die stamp used to form a conventional clipboard clip.

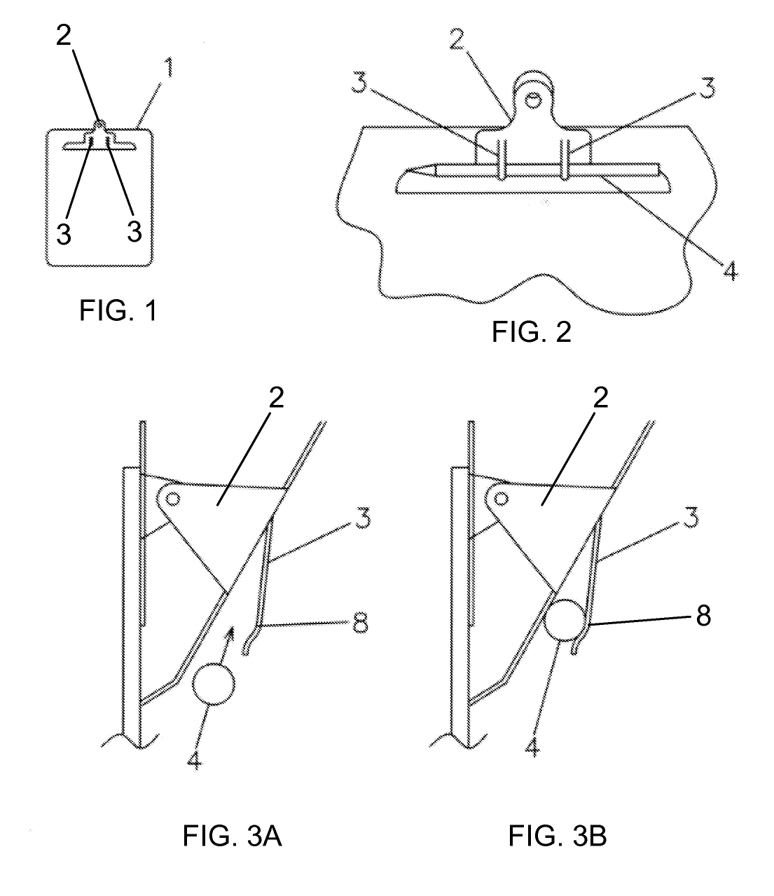

FIG. 1 depicts a clipboard clip in a portrait orientation with at least one flexible tab for removably attaching a writing implement thereto in accordance with a disclosed embodiment. The clipboard 1 includes a board and a clip comprising two tabs formed from, attached to or fastened on the clip as described in detail below. Electronic clipboards are not depicted but may comprise a screen on a surface of the clipboard which when unactivated or in sleep mode may appear as a board. Furthermore, a holder device and jaw component disclosed may be disposed on a clipboard board on a short side of a portrait oriented clipboard and a longer holder device and jaw component may be disposed on a long side of a landscape oriented clipboard.

An embodiment of the device is disclosed wherein the flexible tab(s) to are formed from the clip outer surface by a punching of the tab(s) from the outer surface with a hanging chad retaining the tab(s) to the outer surface at an end proximal a hinge of the clip. Also, the flexible tab(s) may be formed from the outer surface of the clip by a die press operation, an extrusion, a pultrusion, an injection molding and any other manufacturing process or operation of a material from the outer surface of the clip at a time of manufacture of the clip. A further embodiment of the device is disclosed wherein the flexible tab(s) and the outer surface of the clip comprise a single component of the clip. Additionally, the flexible tab(s) may be fastened or adhered to the outer surface of the clip.

FIG. 2 depicts an enlarged view of the clipboard clip area in a portrait orientation in accordance with a disclosed embodiment. The writing implement 4 is held under tabs 3 as part of clip 2. Tabs 3 are elastic and force placed on implement 4 in a motion substantially parallel to the upper surface of the clip can deform tab(s) 3 so that implement 4 can move out of or into the stored position depicted. A single wide tab equal in width to the span between the two tabs 3 depicted may also be formed from the upper or outer surface of the clip 2 sufficient to securely retain the writing implement 4. On the other hand, multiple elastic and flexible tabs 3 greater than the two tabs 3 depicted for a wider clip may be formed parallel to an outer surface of the clip and formed therefrom. For example, clipboards that are set up in a landscape orientation may comprise clips which span the longer dimension of the clipboard and include 3 or 4 tabs for holding the writing implement 4 along its entire length. A length of contact of the removably attached writing implement to the outer surface of the clip is larger than a width of the writing implement.

FIG. 3a depicts a side view of the clip area and how the implement enters the holder in accordance with a disclosed embodiment. This depiction shows how implement 4 may be inserted under tab 3 so that it reaches the arcuate trough 8 in tab 3 where tab 3 holds the implement 4. The flexible tab(s) 3 are adapted to hold the writing implement 4 between the outer surface of the clip 2 and an arcuate portion or trough 8 of the flexible tab(s) 3, the flexible tab(s) 3 and the outer surface of the clip 2 forming in combination a cavity fashioned to removably retain the writing implement 4. Additionally, each tab 3 may be elastically pivoted to the outer surface of the clip 2 to allow each tab 3 to pivot to from the outer surface of the clip 2 and removably retain the writing implement 4.

The trough 8 is depicted with an arcuate form but may also be implemented in a “v” indent and other geometrical forms to retain writing instruments which are either circular, semicircular, triangular and pentagonal etc. in cross section.

FIG. 3b depicts a side view of the clip area and how the implement is held in the holder in accordance with a disclosed embodiment. Another embodiment of the device is disclosed wherein the flexible tab(s) each further comprise an arcuate or upturned upper lip end fashioned to enable a user to pull the tab(s) upward and away from the outer surface. The flexible tab(s) may each comprise a material such as plastic having a memory for its initial formed shape through many elastic deformation motions to remove the writing implement substantially parallel to the upper surface of the clip. Also, a restricting trough, a groove or a ridge may be formed in the gripping appendage(s) adapted to hold the writing implement stable in a position substantially orthogonal to the gripping appendage(s).

An embodiment of the disclosure may further include a restricting feature comprising a clasp and a lock (not depicted) on at least one tab or a set of restricting features on multiple tabs adapted to secure the writing implement in a locked position substantially parallel to the foundation plane. The clasp or lock may couple to the arcuate upper lip on the tab to allow the writing implement to be removed only intentionally by a user and not accidentally through normal use of the holder device and a writing implement.

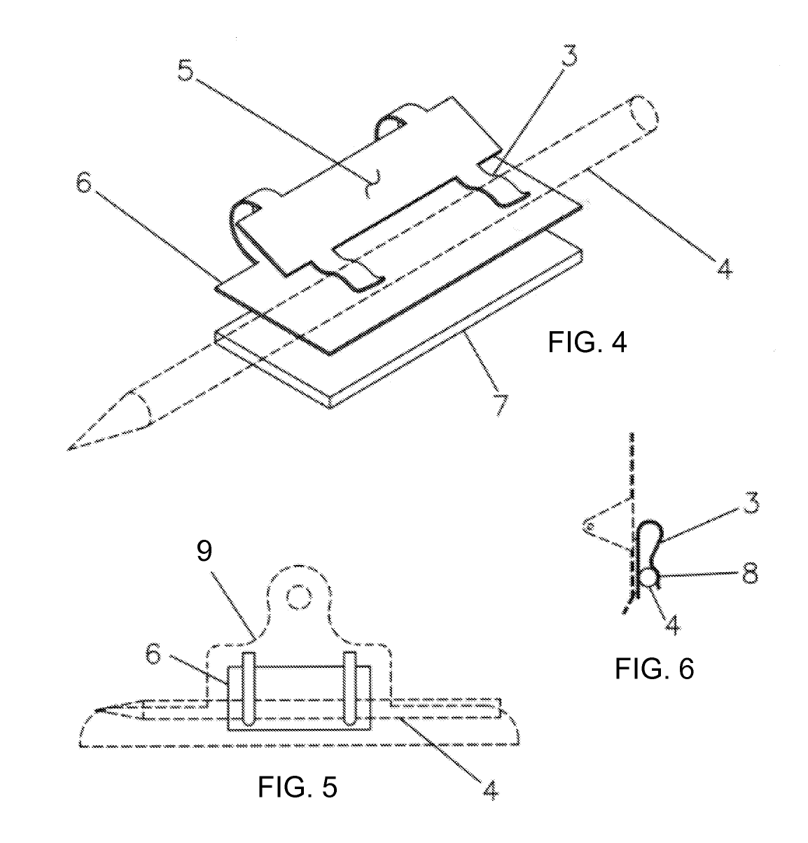

FIG. 4 depicts an isometric view of a separate writing implement holder in accordance with a disclosed embodiment. The drawings depict the separate implement holder 6 formed separately from a conventional clipboard and also showing an area 5 on the holder 6 for advertisement space or a logo or a decoration etc. The separate holder 6 is attached to a conventional clipboard clip with the use of double sided adhesive tape 7 or other adhesive or fastening means. The holder device comprises a jaw having a foundation plane, an upper plane and a spring hinge there between and at least one gripping tab formed parallel to the upper plane opposite the spring hinge and formed therefrom. The gripping tab(s) are adapted to hold the writing implement between the foundation plane of the clip and an arcuate portion of the gripping tab(s). The gripping tab(s) and the foundation plane of the clip form in combination a cavity fashioned to retain the writing implement removable in a motion substantially parallel to the foundation plane.

An embodiment of the holder device is disclosed wherein the cavity is fashioned to open hingedly from a gripping edge of the clip board jaw via an upper lip end fashioned to enable a user to pull the tab(s) upward and away from the outer surface via a manual force on the writing implement in a motion substantially parallel to the foundation plane.

FIG. 5 depicts the separate writing implement holder on the clip board clip in accordance with a disclosed embodiment. The disclosure 6 is depicted attached to the conventional clip and holding a writing implement 4 orthogonal to the tabs 3. Another embodiment of the device is disclosed wherein the gripping tabs comprise an arcuate restricting feature or a set of arcuate restricting features adapted to hold the writing implement in a stable position substantially parallel to the foundation plane. Additionally, the foundation plane, the upper plane, the hinge and the gripping tab(s) comprise a single jaw component. Furthermore, the embodiment may further comprise a jaw component disposed on a conventional clipboard clip 9. A jaw component may be disposed on a clipboard board 1 or on a clipboard clip 9 or multiple jaw components may be disposed on a clipboard along a long side in a landscape orientation.

FIG. 6 depicts a side elevational view of the separate writing implement holder positioned on a clipboard clip in accordance with a disclosed embodiment. A holder for removably attaching a writing implement to a clipboard is additionally disclosed. The holder comprises a foundation plane, an upper plane and a spring hinge there between and at least one gripping appendage formed parallel to the upper plane opposite the spring hinge and formed therefrom. The implement holder is formed in an elongated “u” shaped cavity fashioned to retain the writing implement therein. The spring hinge deflects and the writing implement is removed therefrom responsive to a manual force on the writing implement in a motion substantially parallel to the foundation plane.

An embodiment of the device is disclosed wherein the gripping appendage(s) comprise tabs, arms, fingers, loops and any other shape(s) adapted to retain a writing implement therein. The elongated “u” shaped cavity may open to substantially toward an arcuate gripping edge of the gripping appendage(s). The holder may also be attached to one of a board and a clip of the clipboard via a rivet, a screw, a chemical adhesive, a double sided tape and any other adhesive and fastener.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A device for removably attaching a writing implement to a clipboard clip, comprising at least one tab formed parallel to an outer surface of the clip and formed therefrom, the tab(s) adapted to hold the writing implement between the outer surface of the clip and an arcuate portion of the tab(s), the tab(s) and the outer surface of the clip forming in combination a cavity fashioned to retain the writing implement removable in a motion substantially parallel to the upper surface of the clip.

2. The device of claim 1, wherein the tab(s) are formed from the clip outer to surface by a punching of the tab(s) and are therefore flexible from the outer surface of the clip via a hanging chad retaining the tab(s) to the outer surface at an end proximal a hinge of the clip.

3. The device of claim 1, wherein a length of contact of the removably attached writing implement to the outer surface of the clip is larger than a width of the writing implement.

4. The device of claim 1, wherein the tab(s) are formed from the outer surface of the clip by a die press operation, an extrusion, a pultrusion, an injection molding and any other manufacturing process or operation of a material from the outer surface of the clip at a time of manufacture of the clip.

5. The device of claim 1, wherein the tab(s) each further comprise an upper lip end fashioned to enable a user to pull the tab(s) upward and away from the outer surface.

6. The device of claim 1, wherein the tab(s) and the outer surface of the clip comprise a single component of the clip.

7. The device of claim 1, wherein the tab(s) are fastened or adhered to the outer surface of the clip and comprise a material to allow elastic deformation of the tab.

8. The device of claim 1, wherein the tab(s) are elastically pivoted to the outer surface of the clip to allow each tab to pivot from the outer surface of the clip and removably retain the writing implement.

9. A device for removably attaching a writing implement to a clipboard, comprising a jaw having a foundation plane, an upper plane and a spring hinge there between and at least one gripping tab formed substantially parallel to the upper plane opposite the spring hinge and formed therefrom, the gripping tab(s) adapted to hold the writing implement between the foundation plane of the jaw and an arcuate portion of the gripping tab(s), the gripping tab(s) and the foundation plane of the jaw forming in combination a cavity fashioned to retain the writing implement removable in a motion substantially parallel to the foundation plane.

10. The device of claim 9, wherein the cavity is fashioned to open hingedly from a gripping edge of the clip board jaw via an arcuate upper lip end fashioned to enable a user to pull the tab(s) upward and away from the outer surface

11. The device of claim 9, wherein the upper plane is adapted to allow the display of a logo or advertisement or the like.

12. The device of claim 9, further comprising a restricting feature comprising a clasp and a lock on at least one tab or a set of restricting features on multiple tabs adapted to secure the writing implement in a locked position substantially parallel to the foundation plane.

13. The device of claim 9, wherein the foundation plane, the upper plane, the hinge and the gripping tab(s) comprise a single jaw component.

14. The device of claim 9, further comprising a jaw component disposed on a clipboard board on a short side of a portrait oriented clipboard and a longer jaw component disposed on a long side of a landscape oriented clipboard.

15. The device of claim 9, further comprising a jaw component disposed on a clipboard clip.

16. A holder for removably attaching a writing implement to a clipboard, comprising a foundation plane, an upper plane and a spring hinge there between and at least one gripping appendage formed parallel to the upper plane opposite the spring hinge and formed therefrom, the implement holder formed in an elongated “u” shaped cavity fashioned to retain the writing implement therein, whereby the spring hinge deflects and the writing implement is removed therefrom responsive to a manual force on the writing implement in a motion substantially parallel to the foundation plane.

17. The holder of claim 16, wherein the gripping appendage(s) comprise tabs, arms, fingers, loops and any other shape(s) adapted to retain a writing implement therein.

18. The holder of claim 16, wherein the elongated “u” shaped cavity opens substantially toward an arcuate gripping edge of the gripping appendage(s).

19. The holder of claim 16, wherein the holder is attached to the one of a board and a clip of the clipboard via a rivet, a screw, a glue, a double sided tape and any other adhesive and fastener.

20. The holder of claim 16, further comprising a restricting trough, a groove or a ridge formed in the gripping appendage(s) adapted to hold the writing implement stable in a position substantially orthogonal to the gripping appendage(s).
